(19) United States
(12) Patent Application Publication
(10) Pub. No.: US 2011/0279254 A1
(43) Pub. Date: Nov. 17, 2011

(54) METHOD AND DEVICE FOR CARRYING OUT AN AVOIDANCE MANEUVER

(75) Inventors: Thomas Raste, Oberursel (DE); Peter Lauer, Karben (DE); Bernd Hartmann, Bad Homburg (DE)

(73) Assignee: CONTINENTAL TEVES AG & CO. OHG, Frankfurt (DE)

(21) Appl. No.: 13/147,034

(22) PCT Filed: Jan. 28, 2010
(86) PCT No.: PCT/EP2010/051001

§ 371 Date: Jul. 29, 2011

(30) Foreign Application Priority Data
Feb. 3, 2009 (DE) 10 2009 007 184.9

(51) Int. Cl. B62D 6/00; B62D 7/15; B60Q 1/00; B62D 15/02

(52) U.S. Cl. 340/438; 701/41

(57) ABSTRACT

Disclosed herein is a method and device for carrying out an avoidance maneuver of a motor vehicle. An object in the surroundings of the motor vehicle which is on a collision course is detected. A warning is output to the vehicle driver, to the effect that the motor vehicle is on a collision course, and the steering activity of the vehicle driver is detected. An externally actuable rear-wheel steering device is subsequently switched such that the front wheels and the rear wheels of the motor vehicle are controlled in the same direction. Also, the vehicle movement dynamics effects of the actuation of the externally actuable rear-wheel steering device in the same direction are compensated. A further warning is output to the vehicle driver in order to cause the vehicle driver to perform a greater steering activity necessary as a result of the actuation of the externally actuable rear-wheel steering device.

### CROSS REFERENCE TO RELATED APPLICATIONS

This application is the U.S. National Phase Application of PCT International Application No. PCT/EP2010/051001, filed Jan. 28, 2010, which claims priority to German Patent Application No. 10 2009 007 184.9, filed Feb. 3, 2009, the contents of such applications being incorporated by reference herein.

### FIELD OF THE INVENTION

The invention relates to a method for carrying out an avoidance maneuver of a motor vehicle. In a first method step, an object in the surroundings of the motor vehicle with which the motor vehicle is on a collision course is detected. A warning is then output to the vehicle driver, to the effect that the motor vehicle is on a collision course, and the steering activity of the vehicle driver is detected. An externally actuable rear-wheel steering device is subsequently switched in such a way that the front wheels and the rear wheels of the motor vehicle are controlled in the same direction. The invention also relates to a device for carrying out an avoidance maneuver.

### BACKGROUND OF THE INVENTION

Such a method is known from DE 10 2008 013 988 A1, which is incorporated by reference. In the previously known method, a path for the avoidance maneuver of the motor vehicle determined and the steering system of the motor vehicle is influenced as a function of the determined path. In this context, the previously known method provides that the steering system combines a front-wheel steering function and a rear-wheel steering function in such a way that the front wheels and the rear wheels of the motor vehicle are controlled in the same direction. The effect which is brought about is that actuation of the front wheels and of the rear wheels in the same direction gives rise to a more stable driving behavior during the avoidance maneuver. However, at the same time increased steering effort is necessary for the vehicle driver than is the case with rear wheels which are not steered or are steered in an opposing direction.

### SUMMARY OF THE INVENTION

An aspect of the present invention is therefore to improve a method of the type mentioned at the beginning and a device for carrying out the method to the effect that an avoidance maneuver continues to be capable of being controlled by the vehicle driver using front wheels and rear wheels which are controlled in the same direction.

There is provision here that the vehicle movement dynamics effects of the actuation of the externally actuable rear-wheel steering device in the same direction are compensated. This compensation provides that a further warning is output to the vehicle driver in order to cause the vehicle driver to perform a greater steering activity which is necessary as a result of the actuation of the externally actuable rear-wheel steering device in the same direction.

In one particularly advantageous development of the method according to aspects of the invention, a path is calculated for the avoidance maneuver of the motor vehicle, and, when a deviation is present between the calculated steer angle which is necessary for avoidance and the steer angle which is set by the vehicle driver, the further warning is output to the vehicle driver in order to prompt him to correct the deviation.

A further advantageous development provides that the further warning to the vehicle driver be formed by a torque which is applied by a front-wheel steering device, which can be activated electro-mechanically, and can be felt by the vehicle driver at the steering wheel. The torque points in the direction of the calculated steer angle which is necessary for avoidance. In order to generate the torque, the front-wheel steering device which can be activated electro-mechanically is actuated with the effect of setting the calculated steer angle which is necessary for avoidance. In this context, the calculated steer angle which is necessary for avoidance is set by the front-wheel steering device which can be activated electro-mechanically, if the vehicle driver does not perform any opposing steering movements. If the vehicle driver has taken his hands away from the steering wheel, the calculated steer angle which is necessary for avoidance is therefore set. The vehicle driver is, however, capable at any time of overriding the proposed steer angle and steering in the other direction or locking the steering wheel further than is necessary for avoidance. In other words, the vehicle driver determines the locked steer angle and is merely assisted by the method.

In one development of the inventive idea, there is provision that the first warning to the vehicle driver is formed by vibration or oscillation which is applied by the front-wheel steering device, which can be activated electro-mechanically, and can be felt by the vehicle driver at the steering wheel.

One particularly advantageous development provides that the calculated steer angle which is necessary for avoidance is determined with the following steps:
determination of the distance from the object at the moment when the steering activity of the vehicle driver starts;
calculation of the avoidance path;
calculation of the steer angle which is necessary for avoidance.

In this context, the avoidance path is a circular path, a parabola, a trajectory or a combination of these geometric shapes.

In the case of the device which achieves the above-mentioned advantages, means are provided according to aspects of the invention which compensate the vehicle movement dynamics effects of the actuation of the externally actuable rear-wheel steering device in the same direction and output a further warning to the vehicle driver in order to cause the vehicle driver to perform a greater steering activity which is necessary as a result of the actuation of the externally actuable rear-wheel steering device in the same direction.

The means calculate a path for the avoidance maneuver of the motor vehicle and calculate a deviation between the calculated steer angle which is necessary for avoidance and the steer angle which is set by the vehicle driver, and in that, when a deviation is present, the means output a further warning to the vehicle driver in order to prompt him to correct the deviation. The further warning is generated by a front-wheel steering device which can be activated electro-mechanically and which, when actuation occurs, applies a torque which can be felt by the vehicle driver at the steering wheel.

### BRIEF DESCRIPTION OF THE DRAWINGS

The invention is best understood from the following detailed description when read in connection with the accompanying drawings. Included in the drawings is the following figures:

FIG. 1 shows a schematic illustration of a vehicle having a surroundings sensor for detecting objects in the surroundings of the vehicle;

FIG. 2 shows a schematic illustration of a driver assistance system;

FIG. 3 shows a diagram illustrating the steer angle of the front wheels and of the rear wheels during an avoidance maneuver;

FIG. 4 shows a diagram which compares the steer angle δₛₑₜₚ, set by the vehicle driver, with the necessary, calculated steer angle δ_{act} and illustrates the method according to aspects of the invention, and

FIG. 5a shows a velocity diagram during an avoidance maneuver;

FIG. 5b shows a diagram of the steer angle δₛₑₜₚ, set by the vehicle driver, and the yaw rate during an avoidance maneuver;

FIG. 5c shows a diagram of a torque M which can be felt by the vehicle driver at the steering wheel;

FIG. 5d shows a diagram which illustrates the distance from the object O with which the motor vehicle is on a collision course, and

FIG. 5e shows a diagram of the lateral deviation during an avoidance maneuver.

### DETAILED DESCRIPTION OF THE PREFERRED EMBODIMENTS

Within the sense of the present invention, the steering wheel is representative of all the conceivable man/machine interfaces which a vehicle driver can operate in order to steer and control the motor vehicle, such as for example a joystick or a touchpad.

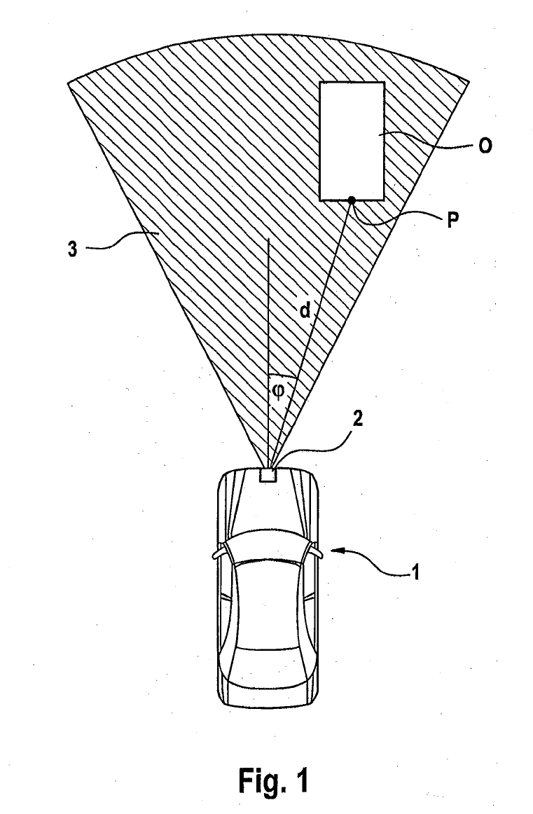

FIG. 1 illustrates by way of example a four-wheel, two-axle vehicle 1 which has a surroundings sensor 2 with which objects O in the surroundings of the vehicle can be detected, which objects are, in particular, further motor vehicles which are moving on the same lane or on an adjacent lane, to the side of and/or in front of the vehicle 1. However, stationary or virtually stationary objects such as, for example, trees, pedestrians or carriageway boundaries are also possible as objects O. For example, a surroundings sensor 2 is shown with a detection range 3 which comprises a spatial angle in front of the vehicle 1 in which, for example, an object O is illustrated. The surroundings sensor 2 is, for example, a LIDAR (Light Detection and Ranging) sensor which is known per se to a person skilled in the art; however, other surroundings sensors can also equally well be used. The sensor measures the distances d from the detected points of an object and the angles φ between the connecting straight lines for these points and the central longitudinal axis of the vehicle, as is illustrated by way of example in FIG. 1 for a point P of the object O. The fronts of the detected objects facing the vehicle 1 are composed of a plurality of detected points to which the sensor signals are transmitted, which produces correlations between points and the shape of an object and determines a reference point for the object O. In this context, for example the central point of the object O or the central point of the detected points of the object can be selected as a reference point. The velocities of the detected points and therefore the velocity of the detected objects cannot be measured directly by means of the LIDAR surroundings sensor 2, in contrast to a radar sensor (Doppler effect). Said velocities are calculated from the difference between the distances measured in successive time steps, in an object-detection unit 21 which operates on a clocked basis. In a similar way, the acceleration of the objects can also be basically determined by double derivation of their positions.

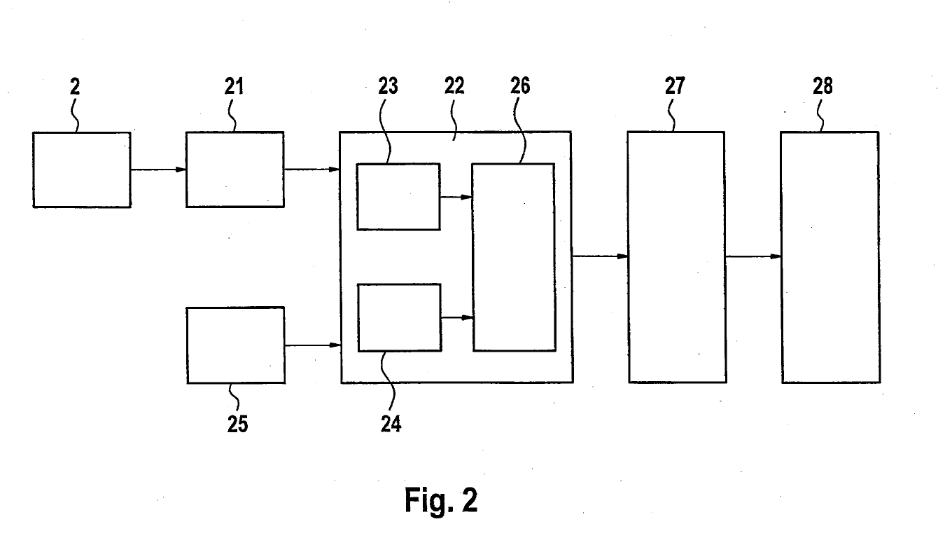

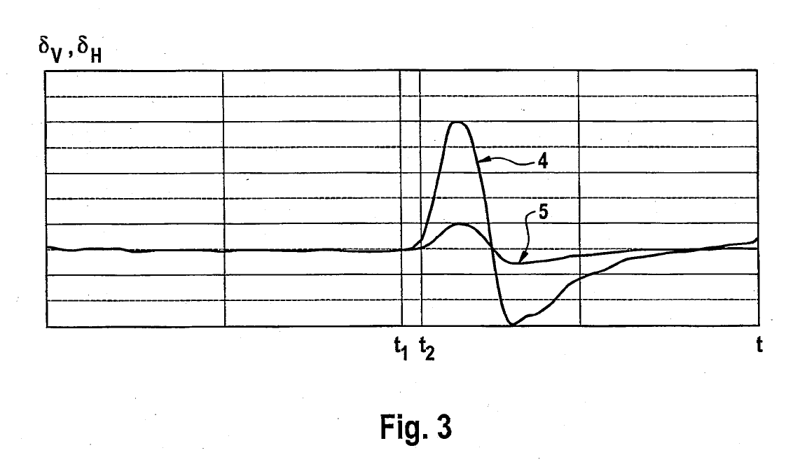

FIG. 2 shows a schematic illustration of a driver assistance system whose components, with the exception of sensors and actuators, are preferably embodied as software modules which are embodied inside the vehicle 1 by means of a microprocessor. As is shown in FIG. 2, the object data are transmitted in the form of electronic signals inside the schematically illustrated driver assistance system to a decision device 22. An object trajectory is determined in the decision device 22 in block 23 on the basis of the information relating to the object O. In addition, a trajectory of the vehicle 1 in block 24 is determined on the basis of information relating to the vehicle movement dynamics state of the vehicle 1, which information is determined using further vehicle sensors 25. In particular, in this context use is made of the vehicle velocity which can be determined, for example, using wheel speed sensors, of the steer angle δ, which is measured by means of a steer angle sensor, at the steerable wheels of the vehicle 1, of the yaw rate and/or of the lateral acceleration of the vehicle 1 which are measured by means of corresponding sensors. Furthermore, it is possible to calculate or estimate model-based variables from the vehicle movement dynamics states of the vehicle which are measured with the vehicle sensors 25. In the decision device 22 inside the block 26 it is then checked whether the motor vehicle 1 is on a collision course with one of the detected objects O. If such a collision course is determined and the collision time (TTC, Time To Collision), i.e. the time period up to the determined collision with the object O, which is also determined in the decision device 22 undershoots a specific value, a triggering signal is transmitted to a path-predefining device 27. The triggering signal causes an avoidance path y(x) to be firstly calculated within the path-predefining device. A starting point for the avoidance maneuver, at which the avoidance maneuver has to be started in order to just be able to avoid the object O, is then determined on the basis of the identified avoidance path y(x). These steps are preferably repeated in time periods until there is no longer any risk of collision owing to changes of course of the object O or of the vehicle 1 or until the vehicle 1 reaches the starting point for an avoidance maneuver. If this is the case, the avoidance path y(x) or parameters representing this path is/are transmitted to a steering actuator controller 28. The latter then actuates a front-wheel steering device V which can be activated electro-mechanically, and said steering actuator controller 28 generates a vibration or an oscillation which can be felt by the vehicle driver at the steering wheel of his motor vehicle 1. This warning X₁ alerts the vehicle driver to the fact that the motor vehicle 1 which is being controlled by him is on a collision course with an object O. The turning in of the vehicle driver is detected by means of the change in the steer angle δᵥ, that is to say by means of the derivation of the steer angle of the front wheels δᵥ over time. After the steering activity δᵥ of the vehicle driver has been detected, an externally actuable rear-wheel steering device H is switched in such a way that the front wheels and the rear wheels of the motor vehicle are controlled in the same direction. This process is illustrated in FIG. 3: the steer angle of the front wheels δᵥ and of the rear wheels δ_{H} is plotted on the ordinate, while the time t is plotted on the abscissa. The curve which is provided with the reference number 4 describes the steer angle δᵥ of the front wheels. The vehicle driver turns in at the time t=t₁. The rear-wheel steering device H is switched at the time t₂ and therefore directly after the steering activity δᵥ of the vehicle driver has been detected, in such a way that the rear wheels are controlled in the same direction as the front wheels. The steer angle δ_{H} of the rear wheels whose profile is provided with the reference number 5 therefore follows the steer angle δᵥ of the front wheels. When front wheels and rear wheels are actuated in opposing directions, the steer angle δ_{H} of the rear wheels would assume a different sign.

The advantage of actuating the front wheels and rear wheels in the same direction during an avoidance maneuver is that a more stable driving behavior is achieved during the avoidance maneuver. However, at the same time a greater steering effort is required for the vehicle driver than is the case with rear wheels which are not steered or are steered in an opposing direction.

The present method therefore provides that the vehicle movement dynamics effects of the actuation of the externally actuable rear-wheel steering device H in the same direction are compensated. Since the vehicle driver is not prepared for the increased steering effort, it is therefore necessary to allow for the fact that the vehicle driver turns in too little to be able to safely drive around the object O. In order to compensate for the increased steering effort, a further warning X₂ is output to the vehicle driver, which causes the vehicle driver to perform a necessary greater steering activity δᵥ, which is necessary due to the actuation of the externally actuable rear-wheel steering device H and of the front-wheel steering device V in the same direction. The additional warning X₂ to the vehicle driver which has just been mentioned is formed here by a torque M which is applied by the front-wheel steering device V which can be activated electro-mechanically. This torque M can be felt by the driver at the steering wheel of his motor vehicle 1. The front-wheel steering device V which can be activated electro-mechanically is actuated here in the direction of the necessary steer angle correction, as a result of which the vehicle driver feels, at the steering wheel, a torque M which suggests to him that he should perform a steer angle correction independently. If the vehicle driver takes his hands away from the steering wheel, the calculated steer angle which is necessary for avoidance is set. However, the vehicle driver is capable at any time of overriding the proposed steer angle and steering in the other direction or locking the steering wheel further than is necessary for avoidance. In other words, the vehicle driver determines the locked steer angle and is merely assisted by the method. What is a necessary steer angle correction here and how this is determined will be explained below: at the time at which a steering activity δᵥ of the vehicle driver is detected, the difference d from the object O is determined and an avoidance path y(x) for the avoidance maneuver of the motor vehicle 1 is calculated. A circular path, a trajectory or a combination of a circular path and a trajectory is possible as an avoidance path y(x). The calculated steer angle δ_{setp, v} which is necessary for avoidance is obtained directly from the calculated avoidance path y(x). Subsequently, the steer angle δ_{act, v} which is set by the vehicle driver is determined continuously and compared with the calculated steer angle δ_{setp, v} which is necessary for avoidance. Given the presence of a deviation Δδᵥ between the calculated steer angle δ_{setp, v} which is necessary for avoidance and the steer angle δ_{act, v} which is set by the vehicle driver, the further warning X₂ is output to the vehicle driver in order to prompt him to correct or minimize the deviation Δδᵥ. In order to generate the warning X₂, the front-wheel steering V, which can be activated electro-mechanically, is actuated with the effect of setting the calculated steer angle δ_{setp, v} which is necessary for avoidance. The torque M which can be felt at the steering wheel therefore points in the direction of the calculated steer angle δ_{setp, v} which is necessary for avoidance.

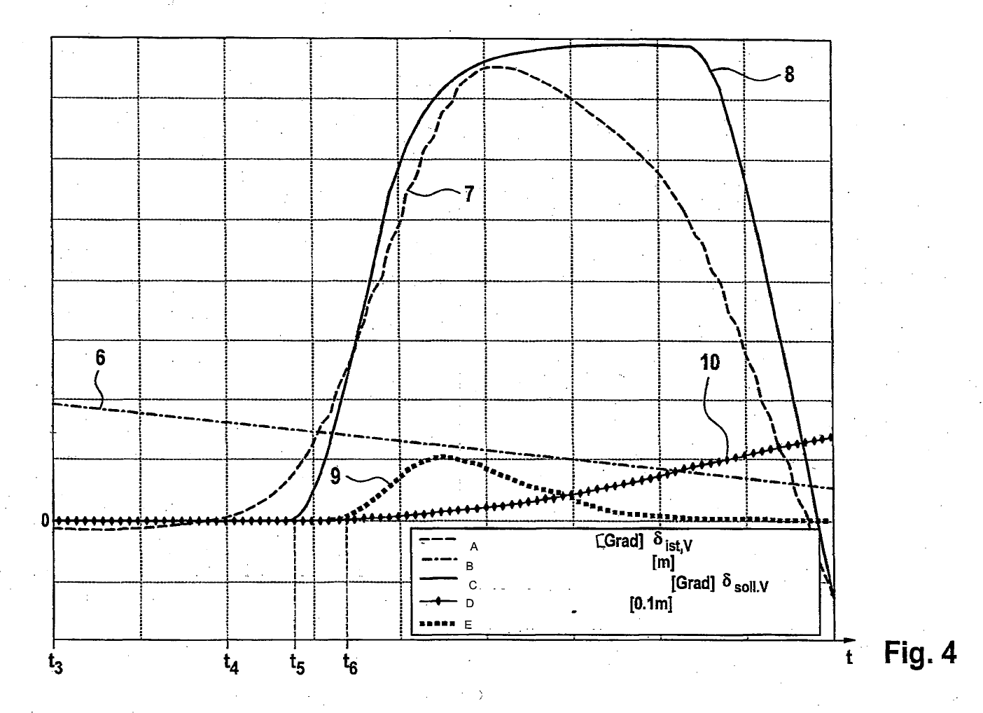

FIG. 4 illustrates a diagram which explains in more detail the method which has just been described. In FIG. 4, the broken line designated by character ‘A’ signifies steer angle set by vehicle driver. The broken line designated by character ‘B’ signifies distance of the radar from the object. The solid line designated by character ‘C’ signifies calculated steer angle. The solid line with diamonds designated by character ‘D’ signifies determined trajectory. The broken line designated by character ‘E’ signifies torque (M) which can be felt by the vehicle driver at the steering wheel (L). The dot-dashed curve represents here the distance d of the motor vehicle 1 from the object O and is provided with the reference number 6. In the time period illustrated in FIG. 4, the distance d decreases continuously, i.e. the motor vehicle 1 approaches the object. However, since the distance d does not drop to zero, it is apparent that a collision is avoided. The steer angle δ_{act, v} which is set by the vehicle driver is illustrated in FIG. 4 with a dashed curve and is provided with the reference number 7. The calculated steer angle δ_{setp, v} which is necessary for avoidance is illustrated as an unbroken curve (reference number 8), and the torque M which can be felt at the steering wheel is represented as a dotted curve (reference number 9).

As is directly apparent from FIG. 4, the vehicle driver turns in at the time t₄, i.e. a steering activity of the vehicle driver is detected. The calculated steer angle δ_{setp, v} which is necessary for avoidance and which is available at the time t₅ is obtained directly from the subsequent calculation of the avoidance path y(x). At the time t₆, the warning X₂ is output in the form of a torque M to the vehicle driver. As already mentioned, the vehicle driver is requested to minimize the deviation Δδᵥ between the set steer angle δ_{act, v} and the calculated steer angle δ_{setp, v}. The torque M causes the calculated steer angle δ_{setp, v} which is necessary for avoidance to be set, if the vehicle driver were to take his hands away from the steering wheel. The curve which is provided with the reference number 10 represents the lateral deviation of the calculated avoidance path y(x).

Of course, it is conceivable to return the vehicle driver back to the position corresponding to the initial position after the avoidance. A further torque M is therefore predefined to the vehicle driver at the steering wheel, which further torque M returns him to his original direction of travel which he was following before the avoidance maneuver. If a further object with which the motor vehicle is on a collision course appears during the described method or subsequent thereto, the method is re-started.

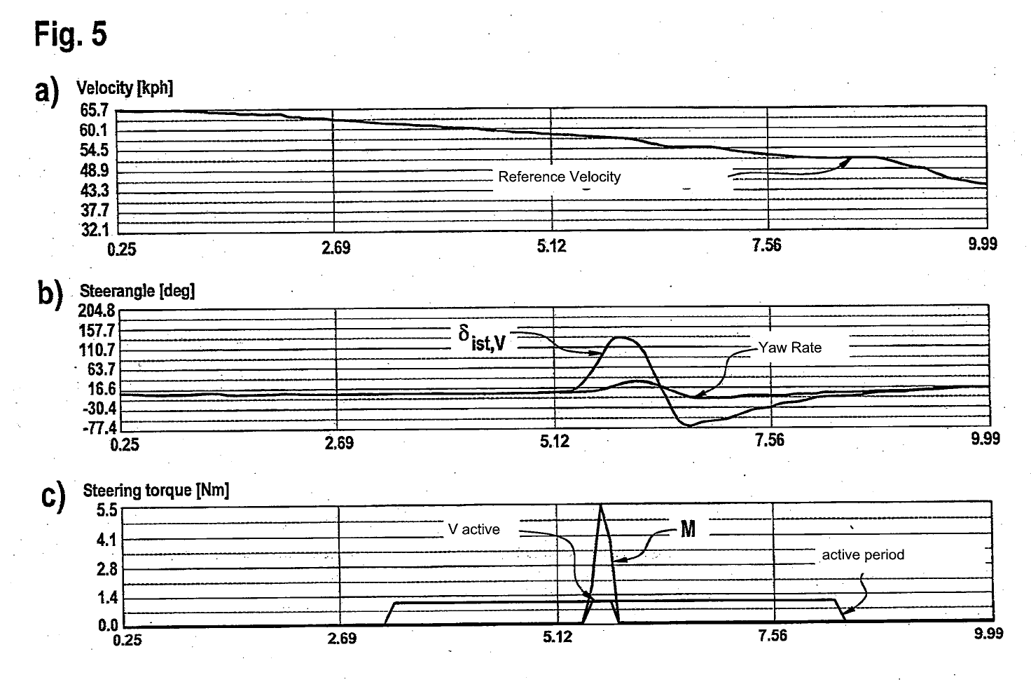

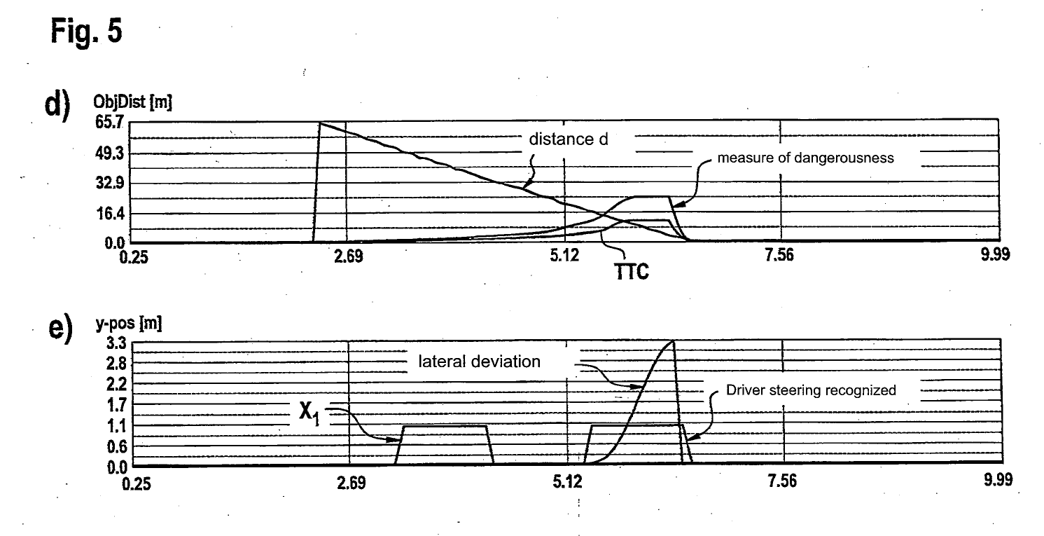

A number of variables during an avoidance maneuver are contrasted in FIGS. 5a to 5e. It is to be noted that all the diagrams in FIGS. 5a to 5e are represented at the same time and therefore run parallel to one another. For the sake of better clarity, the diagrams are, however, illustrated separately. FIG. 5a illustrates the velocity of the motor vehicle 1. FIG. 5b juxtaposes the driver steer angle δ_{act, v} set by the vehicle driver and the yaw rate acting on the motor vehicle.

FIG. 5c illustrates the time period in which the front-wheel steering device V is actively actuated in order to generate the torque M at the steering wheel. FIG. 5d finally shows the distance d of the motor vehicle 1 from the object O. It is clearly apparent that the motor vehicle 1 is moving toward the object O and the distance d is continuously decreasing. At the same time, the measure of dangerousness increases. The determined collision time (TTC) is also a measure of the dangerousness.

FIG. 5e illustrates the first warning X₁ which is output to the vehicle driver and is formed by means of vibration or oscillation at the steering wheel. Furthermore, the lateral deviation of the calculated avoidance path y(x) is illustrated, as is the detection of the steering activity δᵥ of the vehicle driver.

In an alternative embodiment it is conceivable to apply an additional steer angle δ_{add} instead of a further warning X₂ in the form of a torque, which can be felt at the steering wheel and is in a predefined steering direction, which additional steer angle δ_{add} reduces the deviation Δδᵥ between the calculated steer angle δ_{setp, v} which is necessary for avoidance and the steer angle δ_{act, v} which is set by the vehicle drive, so that the avoidance maneuver can be safely carried out. This additional steer angle δ_{add} is therefore applied independently of the driver's request and forces the motor vehicle 1 onto the calculated avoidance path y(x). This correction in the event of deviation from the calculated avoidance path y(x) can be carried out with a variable ratio steering system as a front-wheel steering device. In this alternative embodiment, a further warning X₂ to the vehicle driver is therefore dispensed with and instead the calculated steer angle δ_{setp, v} which is necessary for avoidance is set. The vehicle driver is assisted in this alternative method to the effect that his vehicle is forced onto the avoidance path provided. In contrast, further changes compared to the method described in detail are not necessary since all the other method steps have an identical sequence.

The advantage of the described methods is that an avoidance maneuver is carried out safely and with a stable driving behavior and collisions are reliably avoided.

1-13. (canceled)

14. A method for carrying out an avoidance maneuver of a motor vehicle comprising the steps of:
detecting an object in the surroundings of the motor vehicle, with which object the motor vehicle is on a collision course;
outputting of a warning (X₁) to the vehicle driver;
detecting a steering activity (δᵥ) of the vehicle driver; and
switching of an externally actuable rear-wheel steering device (H) in such a way that the front wheels and the rear wheels of the motor vehicle are controlled in the same direction,
wherein the vehicle movement dynamics effects of the actuation of the externally actuable rear-wheel steering device (H) in the same direction are compensated.

15. The method as claimed in claim 14, wherein for the purpose of compensation a further warning (X₂) is output to the vehicle driver in order to cause the vehicle driver to perform a greater steering activity (δᵥ) which is necessary as a result of the actuation of the externally actuable rear-wheel steering device (H) in the same direction.

16. The method as claimed in claim 14, wherein an avoidance path (y(x)) is calculated for the avoidance maneuver of the motor vehicle, and in that, when a deviation (Δδᵥ) is present between the calculated steer angle (δ_{setp, v}) which is necessary for avoidance and the steer angle (δ_{act, v}) which is set by the vehicle driver, the further warning (X₂) is output to the vehicle driver in order to prompt him to correct the deviation (Δδᵥ).

17. The method as claimed in claim 14, wherein a further warning (X₂) to the vehicle driver is formed by a torque (M) which is applied by a front-wheel steering device (V), which can be activated electro-mechanically, and can be felt by the vehicle driver at the steering wheel (L).

18. The method as claimed in claim 17, wherein the torque (M) points in the direction of the calculated steer angle (δ_{setp, v}) which is necessary for avoidance.

19. The method as claimed in claim 17, wherein in order to generate the torque (M), the front-wheel steering device (V) which can be activated electro-mechanically is actuated with the effect of setting the calculated steer angle (δ_{setp, v}) which is necessary for avoidance.

20. The method as claimed in claim 18, wherein the calculated steer angle (δ_{setp, v}) which is necessary for avoidance is set by the front-wheel steering device (V) which can be activated electro-mechanically, if the vehicle driver does not perform any opposing steering movements.

21. The method as claimed in claim 14, wherein the first warning (X₁) to the vehicle driver is formed by vibration or an oscillation which is applied by the front-wheel steering device (V), which can be activated electro-mechanically, and can be felt by the vehicle driver at the steering wheel (L).

22. The method as claimed in claim 16, wherein the calculated steer angle (δₛₑₜₚ) which is necessary for avoidance is determined with the following steps:
determining the distance (d) from the object (O) at the moment when the steering activity (δᵥ) of the vehicle driver starts;
calculating an avoidance path (y(x));
calculating the steer angle (δ_{setp, v}) which is necessary for avoidance.

23. The method as claimed in claim 22, wherein the avoidance path (y(x)) is a circular path, a parabola, a trajectory or a combination thereof.

24. A device for carrying out an avoidance maneuver of a motor vehicle, comprising:
a surroundings detecting system (U) for detecting an object (O) in the surroundings of the motor vehicle, with which object (O) the motor vehicle is on a collision course;
a warning device (V) for outputting a warning (X₁, X₂) to the vehicle driver;
a steer angle sensor (S) for detecting a steering activity (δᵥ) of the vehicle driver, and
an externally actuable rear-wheel steering device (H) which is switched in such a way that the front wheels and the rear wheels of the motor vehicle are controlled in the same direction,
wherein means are provided which compensate the vehicle movement dynamics effects of the actuation of the externally actuable rear-wheel steering device (H) in the same direction and output a further warning (X₂) to the vehicle driver in order to cause the vehicle driver to perform a greater steering activity (δᵥ) which is necessary as a result of the actuation of the externally actuable rear-wheel steering device (H) in the same direction.

25. The device as claimed in claim 24, wherein the means calculate an avoidance path (y(x)) for the avoidance maneuver of the motor vehicle and a deviation (Δδᵥ) between the calculated steer angle (δ_{setp, v}) which is necessary for avoidance and the steer angle (δ_{act, v}) which is set by the vehicle driver, and, when a deviation (Δδᵥ) is present, the means output a further warning (X₂) to the vehicle driver in order to prompt him to correct the deviation (Δδᵥ).

26. The device as claimed in claim 24, wherein when actuation occurs, a front-wheel steering device (V) which can be activated electro-mechanically applies a torque (M) which can be felt by the vehicle driver at the steering wheel (L).
